(19) United States
(12) Patent Application Publication
(10) Pub. No.: US 2014/0038679 A1
(43) Pub. Date: Feb. 6, 2014

(54) METHODS OF ADMINISTERING WAGERING GAMES AND RELATED SYSTEMS AND APPARATUSES

(71) Applicant: Roger M. Snow, Las Vegas, NV (US)

(72) Inventor: Roger M. Snow, Las Vegas, NV (US)

(73) Assignee: SHUFFLE MASTER, INC., Las Vegas, NV (US)

(21) Appl. No.: 13/563,491

(22) Filed: Jul. 31, 2012

(51) Int. Cl. A63F 1/00; A63F 13/00

(52) U.S. Cl. 463/11; 273/292

(57) ABSTRACT

A card wagering game wherein a complete dealer hand is dealt face up before players are given an election to fold or to place a play wager, wherein increasing payouts are awarded for beating dealer hands of increasingly higher rank, or both.

### FIELD

The disclosure relates generally to methods of administering wagering games for casinos and other gaming establishments, and related systems and apparatuses. More specifically, disclosed embodiments relate to methods of, and systems and apparatuses for, administering wagering games wherein players may elect to fold or place a play wager after seeing a complete dealer hand, wherein increasing amounts are paid as payouts for winning against increasingly higher-ranked hands held by the dealer, or both.

### BACKGROUND

Poker is a popular wagering game played in casinos and other gaming establishments. Many variants of poker have been developed including, for example, five card draw, five card stud, seven card stud, Mississippi Stud™, Texas Hold'em, and Ultimate Texas Hold' em™. However, avid players are generally open to, and sometimes specifically seek out, new and more interesting ways to play poker games, particularly when the reward for a winning outcome at the end of a round of play, or the odds of achieving a winning outcome, may be enhanced.

For example, U.S. Patent Application Pub. No. 2002/0195775, published Dec. 26, 2002, to Webb et al., discloses a betting structure for a poker game wherein players are required to place an ante wager at the game outset, may elect to place or may be required to place one or more bonus wagers at the game outset, and are required to elect to fold, or to place a play wager, at an intermediate point in the game. As another example, U.S. Patent Application Pub. No. 2005/0242506, published Nov. 3, 2005, to Yoseloff, discloses a poker game played against a pay table, wherein odds payouts are made for achieving hands of designated ranks.

### BRIEF SUMMARY

Embodiments of the disclosure comprise card wagering games wherein a complete dealer hand is dealt face up before players are given an election to fold or to place a play wager, wherein increasing payouts are awarded for beating dealer hands of increasingly higher rank, or both.

In some embodiments, methods of administering wagering games may comprise accepting an initial wager from each player. A partial hand may be dealt to each player, at least one card of the partial hand for each player being dealt face up. A complete hand may be dealt to the dealer, face up. An election to fold, wherein the initial wager is collected by the house, or an additional wager, wherein the initial wager remains in play, may be received from each player. A complete hand may be dealt to each player who made the additional wager and revealing the complete hand for each player who made the additional wager. The initial and additional wagers may be taken when a hand of a respective player is ranked lower than the hand of the dealer. A payout may be paid when a hand of a respective player is ranked higher than the hand of the dealer.

In other embodiments, method of administering wagering games may comprise accepting an initial wager from each player. A partial hand may be dealt to each player, at least one card of the partial hand for each player being dealt face up. A complete hand may be dealt to the dealer. An election to fold, wherein the initial wager is collected by the house, or an additional wager, wherein the initial wager remains in play, may be received from each player. A complete hand may be dealt to each player who made the additional wager and revealing the complete hand for each player who made the additional wager. The initial and additional wagers may be taken when a hand of a respective player is ranked lower than the hand of the dealer. A first payout may be paid on the initial wager when a hand of a respective player is ranked higher than the hand of the dealer. A second, odds payout according to a pay table may be paid on the additional wager when the hand of the respective player is ranked higher than the hand of the dealer, wherein increasing amounts are paid for winning against increasingly higher-ranked hands held by the dealer.

In yet other embodiments, methods of administering wagering games may comprise a dealer accepting an ante wager that a player hand rank will exceed a dealer hand rank. The dealer may accept a blind wager that pays when the player hand beats the dealer hand and the player hand is a predetermined winning hand of at least a selected rank. Cards may be dealt to each player and the dealer. At least one player card may be displayed to each respective player. Either an election to fold or a play wager to continue participation in the game may be received from each player. All player and dealer cards may be revealed and best poker hands from the revealed cards may be determined for each respective player and the dealer. The ante, blind, and play wagers may be taken when the dealer hand outranks the player hand. A payout may be paid on the ante and play wagers when the player hand outranks the dealer hand, wherein an odds payout is made on the play wager for winning against predetermined dealer hands.

In still other embodiments, methods of administering wagering games may comprise a dealer accepting at least one wager from each player. The dealer may deal a complete dealer hand, face up. The dealer may deal at least one player card to each player. The dealer may permit the player to view at least one player card. The dealer may receive an election from each player after viewing the at least one player card to fold or to make a play wager. Additional cards may be dealt to each player still participating to complete a player hand for each respective player. The player cards may be revealed and a best hand composition for each respective player and the dealer may be determined. The hand composition of the dealer hand may be compared to each player hand using poker rankings to determine whether each respective player wins or loses with respect to the dealer. A payout may be awarded to each player holding a winning hand.

Further embodiments may include one, some, or all of the following. The acts of the dealer may be carried out by a visual representation of a dealer, the visual representation being generated and/or displayed by a computer. The visual representation may be a virtual person (an animation), or, may be the transmission of an actual person. The visual representation may be part of an on-line gaming experience of the disclosed game. The acts described in this disclosure associated with a dealer, including dealing cards, displaying or turning cards over, receiving or paying bets, or any other actions, may be represented in any way when used in an on-line environment. For example, the cards associated with a dealer action, described as being dealt or otherwise handled by a dealer, may appear as virtual cards or as transmitted pictures of physical cards. This may include a display of virtual card decks where each deck, individual card, and hand is displayed to an on-line player in a manner consistent with the game play disclosed herein, but may or may not include a visual representation of a dealer with the cards. Likewise, betting activity may be displayed in any manner to a player, including but not limited to virtual chips, betting pools, numbers, or other indicia of a bet amount.

The on-line experience may involve players playing remotely (in a different physical location) from the dealer, the location of a game server, or both, interacting through a networked connection that may include but is not limited to the Internet. The online game play may involve players who are also physically remote from each other. Remote connections use networks typically involving several types of network links, including but not limited to the Internet. Networked connections allowing physically remote players to play a game using a game server or system are part of an implementation of a virtual or on-line gaming environment.

The actions described in this disclosure as the acts of a player, including any betting, card selection (if any), card discards (if any), or any other actions, may be carried out over a network where the indicated actions are received as input to a device. The input receiving device is typically physically remote from the game server or game host and connected over a long distance network, but could be implemented over a wired or wireless LAN in one building, or even in one room, for example. In one embodiment, game play generated at the server or host location may be displayed on the same device as the receiving device. Some embodiments may choose to have game play conveyed to remote players in devices separate from the devices receiving input from a player, such as public screens or publicly broadcast data about a game coupled with individual or private input devices. The reception of an input at a device may be accomplished through any technology adapted for the use, including but not limited to keypads, keyboards, touchpads, mice, optical location devices, eye movement/location detectors, sound input devices, etc. When discussing a device, it is understood the device may comprise multiple components and be complex, including hardware components combined with firmware and/or software, and may itself be a subcomponent of a larger system.

Yet other embodiments comprise apparatuses and systems for administering wagering games according to embodiments of the disclosure.

### BRIEF DESCRIPTION OF THE DRAWINGS

While the specification concludes with claims particularly pointing out and distinctly claiming what are regarded as embodiments of the disclosure, various features and advantages of embodiments encompassed by the disclosure may be more readily ascertained from the following description when read in conjunction with the accompanying drawings, in which:

FIG. 1 is a flow chart diagram of a method of administering a wagering game;

FIG. 2 is a diagram of a playing surface for implementation of the wagering game;

FIG. 3 is an enlarged diagram of one of the player positions of FIG. 2;

FIG. 4 is a perspective view of an individual electronic gaming device configured for implementation of embodiments of wagering games;

FIG. 5 is a top view of a suitable table configured for implementation of embodiments of wagering games;

FIG. 6 is a perspective view of another embodiment of a suitable table configured for implementation of embodiments of wagering games having a virtual dealer;

FIG. 7 is a schematic block diagram of a gaming system for implementing waging games according to an embodiment; and

FIG. 8 is a high-level block diagram of a computer for acting as a gaming system according to one embodiment.

### DETAILED DESCRIPTION

The illustrations presented herein are not meant to be actual views of any particular act in a method of administering a wagering game, apparatus or system for use in administering a wagering game, or component thereof, but are merely idealized representations employed to describe illustrative embodiments. Thus, the drawings are not necessarily to scale. Additionally, elements common between figures may retain the same or similar numerical designation.

The terms “gaming,” “gambling,” or the like, refer to activities, games, sessions, rounds, hands, rolls, operations, and other events related to wagering games such as web games, casino games, card games, dice games, and other games the outcome of which is at least partially based on one or more random event(s) (“chance” or “chances”), and on which wagers may be placed by a player. In addition, the word “wager,” “bet,” “bid” or the like, refer to any type of wagers, bets or gaming ventures that are placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that are “play for pay” as well as “play for fun,” as will be described in more detail below.

In some embodiments, methods of, and systems and apparatuses for, administering wagering games may include granting players an option to fold or place a play wager after seeing a complete dealer hand, increasing amounts are paid as payouts for winning against increasingly higher-ranked hands held by the dealer, or both. More specifically, methods of, and systems and apparatuses for, administering wagering games may be used to implement a card game comprising receiving a first wager from players, dealing a dealer hand face up, receiving from each player an election to fold or a second wager to remain in the game, and paying increasing amounts as payouts on at least one of the first and second wagers for winning against increasingly higher-ranked hands held by the dealer.

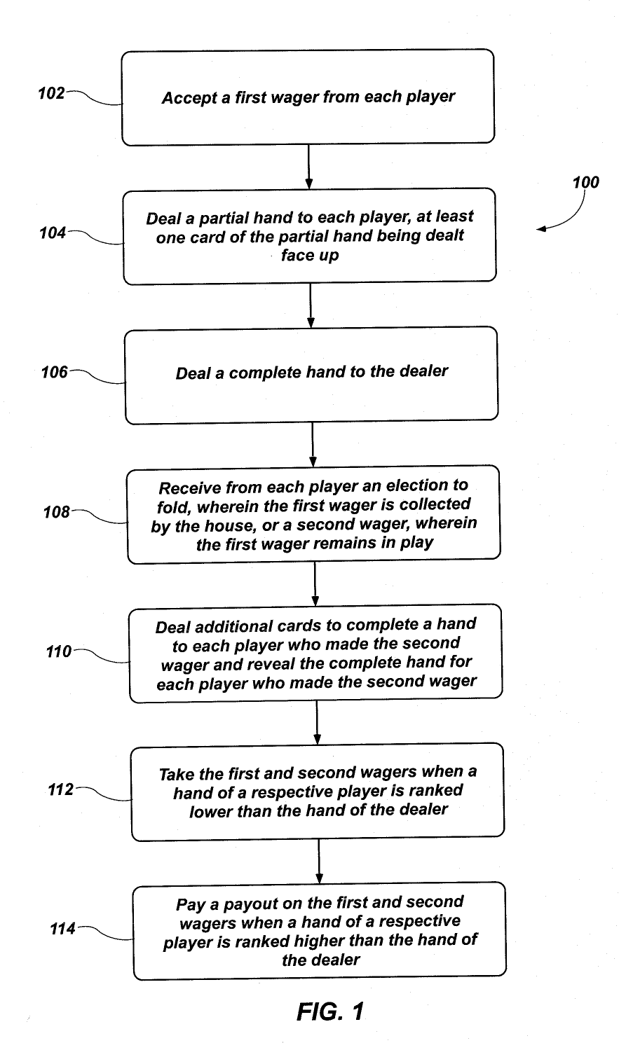

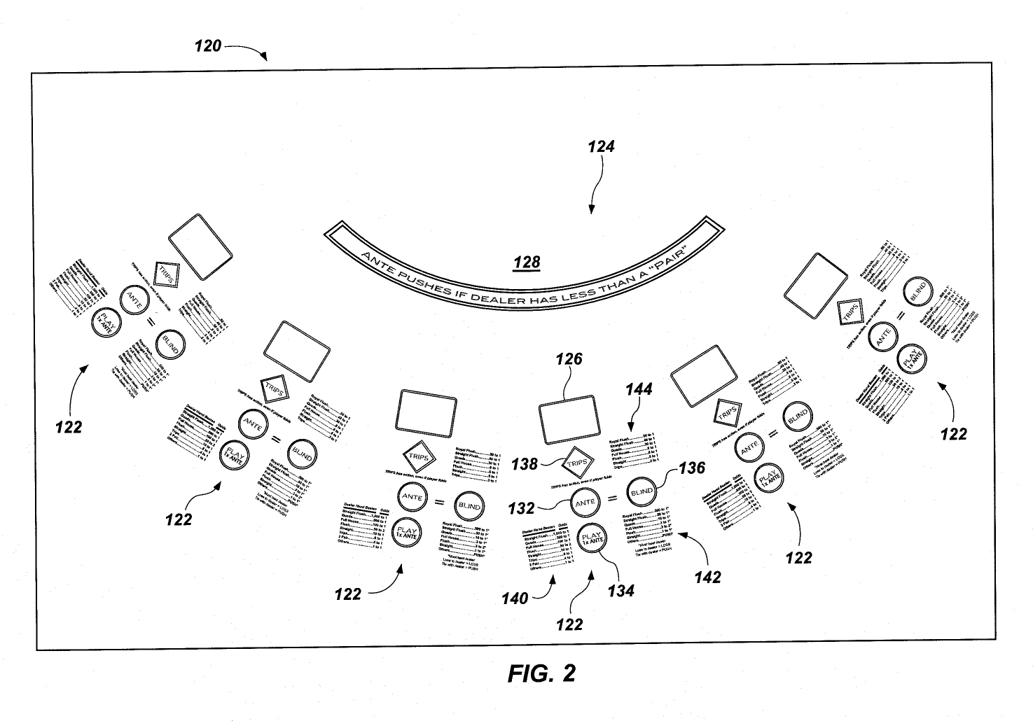

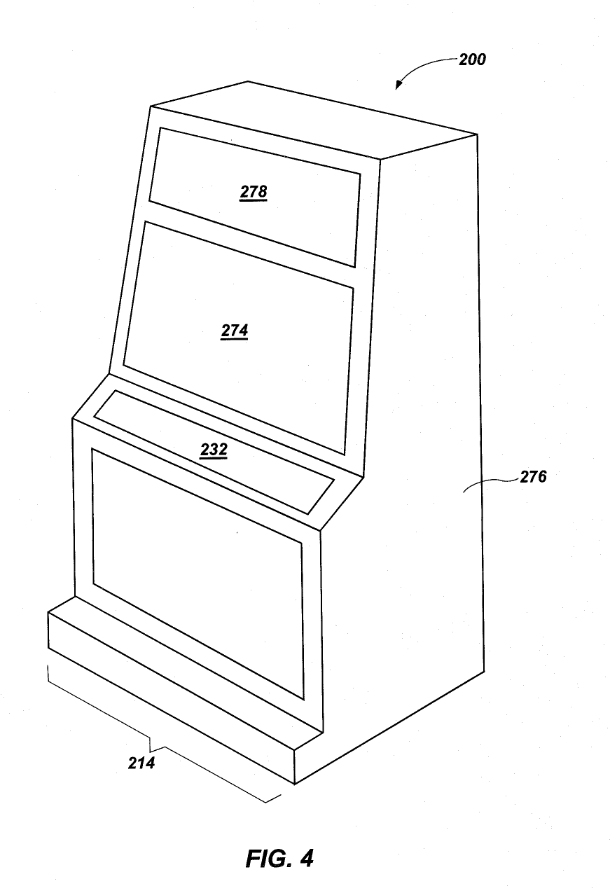

Referring to FIG. 1, a flow chart diagram of a method 100 of administering such a wagering game is shown. The method 100 may comprise accepting a first wager from each player, as indicated at 102. The first wager may comprise, for example, an initial or ante wager which is required for players to participate in the wagering game. The first wager may comprise a bet that a hand held by a respective player will outrank a hand held by the dealer in accordance with the rules of poker or the rules of poker variants being played at this game. In one embodiment, the ranking rules may be the same as, or based on, a variant of 3, 5, 6, or 7 card stud. In one embodiment, the hand ranking rules being used may be prominently displayed to all players. The first wager may be accepted, for example, by physically receiving money or a representation of money (e.g., a chip or token) or by receiving electronic authorization to charge a player account (e.g., a credit account, a bank account). More specifically, the first wager may be accepted, for example, by physically receiving chips within a first wager position 132 on a playing surface 120 of a playing table 118 or 300(see FIGS. 2, 3, and 5) or by receiving electronic authorization at a processor 314, 328, or 542 to charge a player account via a player interface 232, 316, 432, 520, 550, or 554 (see FIGS. 4 through 8), where the player interface may be remotely located from the dealer or game server.

In some embodiments, the method 100 may comprise accepting a blind wager from at least one player at the same stage of play of a round of the card game as the first wager. In other words, the blind wager may be placed before any information about the hands to be held by the dealer or the respective player at the conclusion of the round of the wagering game is revealed to the players. The blind wager may comprise a bet that a hand held by a respective player will be a predetermined rank or higher and will outrank a hand held by the dealer in accordance with poker hand rankings or poker variant hand rankings at the conclusion of the round of the wagering game. The blind wager may be mandatory for at least one player in some embodiments. For example, one of the players participating in the wagering game may be required to place the blind wager, while others may choose whether to place the blind wager. As another example, all of the players may be required to place the blind wager to participate in the wagering game. In other embodiments, the blind wager may be optional for all the players. The blind wager may be accepted by performing any of the actions described previously in connection with acceptance of the first wager. In one embodiment, the chips would be physically received within a blind wager position 136 on the playing surface 120 of the playing table 118 or 300 (see FIGS. 2, 3, and 5), or a virtual (remote) input corresponding to the same bet.

In some embodiments, the method 100 may comprise accepting a bonus wager from at least one player at the same stage of play of a round of the card game as the first wager. The bonus wager may comprise a bet that a player will hold a hand of a predetermined rank or higher at the conclusion of the round of the wagering game. For example, the bonus wager may comprise a bet that the player will hold a three of a kind or better at the conclusion of the round (i.e., a “trips” bet). Placing the bonus wager may be optional. The bonus wager may be accepted by performing any of the actions described previously in connection with acceptance of the first wager. In one embodiment, the chips would be physically received within a bonus wager position 138 on the playing surface 120 of the playing table 118 or 300 (see FIGS. 2, 3, and 5), or a virtual (remote) input corresponding to the same bet.

A partial hand may be dealt to each player, with at least one card of the partial hand being dealt face up, as indicated at 104 (FIG. 1). When it is said that a “partial hand” may be dealt to each player, it is meant that fewer cards than the total number of cards that will ultimately be made available to a respective player to form a hand are dealt face up. The exact number of cards dealt at this stage may be smaller than, or equal to, the number that will be available to be used to form a hand or that will be actually used to form a hand. In some embodiments, all the cards dealt to each player at this stage may be dealt face up. For example, three cards may be dealt to each player with all three cards being dealt face up. In other embodiments, at least one of the cards dealt to each player at this stage may be dealt face down. For example, five cards may be dealt to each player with only two being dealt face up.

In some embodiments, at least one of the cards dealt to the players at this stage may be a community card, which may be available to each of the players to form a hand. In some embodiments, the community cards may be dealt face up. For example, three community cards may be dealt face up. In other embodiments, at least one of the community cards may be dealt face down. For example, four community cards may be dealt, with three of the community cards being dealt face down.

Any combination of individual player cards and community cards may be dealt at this stage, so long as at least one card available to each player is dealt face up. For example, two community cards may be dealt face up and each player may be dealt one player card face up. As another example, one community card may be dealt face up and each player may be dealt two player cards face up. As yet another example, four community cards may be dealt face down and three cards may be dealt to each player face up.

Dealing the cards to each player may comprise, for example, physically placing playing cards in each participating player position or electronically displaying representations of playing cards (e.g., images, text, or both) for each participating player position. More specifically, the cards may be dealt, for example, by physically distributing playing cards within designated player card areas 126 in each participating player position 122, designated community card areas (not shown), or both on a playing surface 120 of a playing table 118 or 300 (see FIGS. 2, 3, and 5) or displaying electronic representations of randomly generated playing cards on a screen or on screens 274, 316, 330, 432, 464, 460, 520, or 558 for each participating player station (see FIGS. 4 through 8). In one embodiment, the electronically generated cards may be displayed to remote players over one or more networks.

A complete hand may be dealt to the dealer, as indicated at 106 (FIG. 1). In some embodiments, at least one card of the hand dealt to the dealer may be dealt face up, which may enable players to evaluate the hand dealt to the dealer or the possible hands dealt to the dealer before making any further decisions, such as, for example, placing wagers other than the first, blind, and bonus wagers. For example, an entire hand of dealt to the dealer may be dealt face up, which may enable players to know a rank of the dealer's hand before making any further decisions. As another example, seven cards may be dealt to the dealer with three of the cards being dealt face up. In other embodiments, the hand dealt to the dealer may be dealt face down.

In some embodiments, dealing the hand to the dealer may comprise dealing community cards. For example, the community cards dealt to the dealer may be the same community cards dealt to the players, making them available to form a hand for each respective participant. In other embodiments, the hand dealt to the dealer may comprise cards dealt to the dealer alone. For example, community cards that are available to the players may not be available to the dealer for forming a hand.

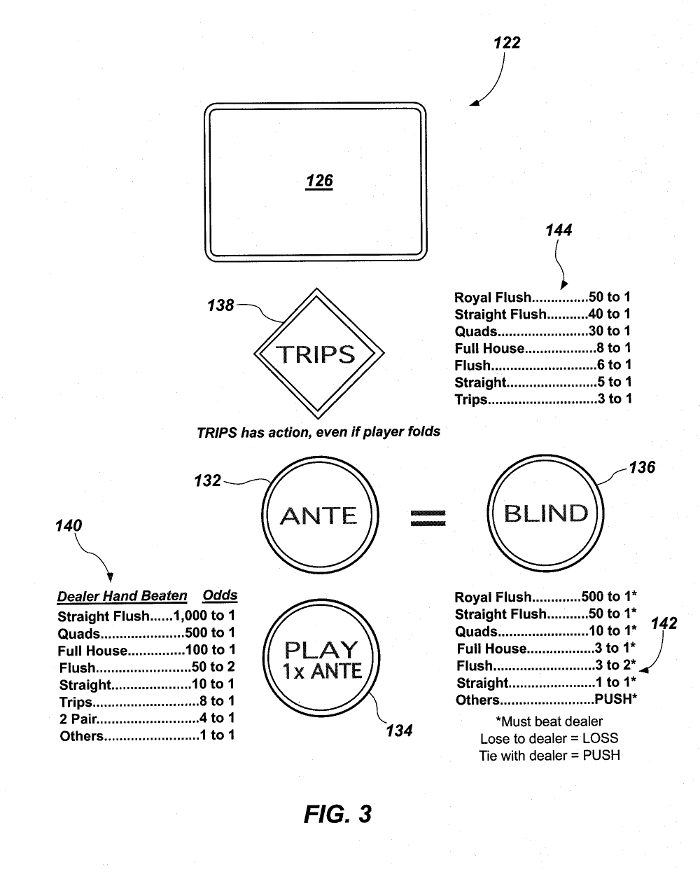

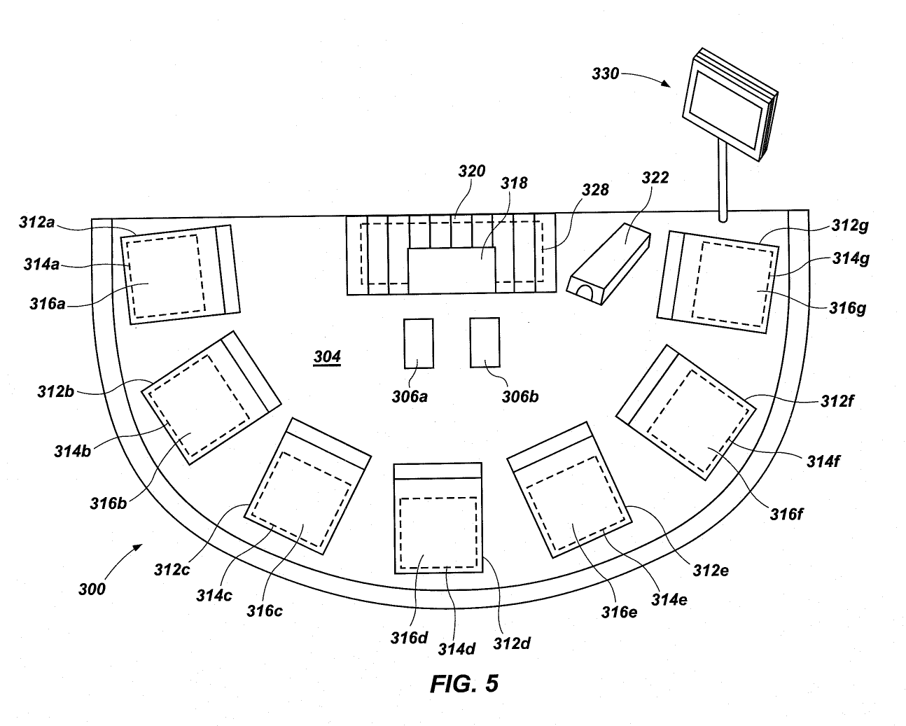

In some embodiments, the dealer must hold a hand of a predetermined rank or higher to participate in the wagering game. For example, the dealer may be required to hold an Ace high or better, a pair or better, or two pair or better to continue the round of play against the first wager. If the hand dealt to the dealer is ranked lower than the predetermined rank, at least the first wagers (e.g., ante wagers) placed during that round of play may be returned to the players (i.e., the wagers are a push) in some embodiments. The first wagers may be returned, for example, by physically giving money or a representation of money that had been wagered back to the player or by granting electronic authorization to transfer funds back to a player account. More specifically, the first wagers may be returned, for example, by permitting each player to physically collect chips from the first wager positions 132 within the respective player positions 122 on a playing surface 120 of a playing table (see FIGS. 2 and 3) or by granting electronic authorization at a processor 314, 328, or 542 to transfer funds from an account server 510 to a player account (see FIGS. 5, 7, and 8). Players may still be eligible to win the blind and bonus wagers in such embodiments. In other embodiments, all wagers, including the first, blind, and bonus wagers, may be a push when the dealer holds a hand ranked lower than the predetermined rank.

The cards may be dealt to the dealer by performing any of the actions described previously in connection with dealing cards to each player, with the exception that cards may be physically distributed within a designated dealer card area 128, a community card area (not shown), or both on the playing surface 120 of a playing table 118 or 300 (see FIGS. 2, 3, and 5) and that electronic representations of dealer cards may be displayed on a screen or screens 274, 330, 460, 464, 558 viewable from each player position (see FIGS. 4 through 8).

Still referring to FIG. 1, an election to fold or a second wager may be received from each player, as indicated at 108. If a player folds, the first wager may be collected by the house. If a folding player placed the blind wager, the blind wager may also be collected by the house. In some embodiments, the cards held by a player who folds may be collected at this stage of the wagering game and the player may not be permitted to participate further until the round is completed. In other embodiments, the cards held by the player who folds may be retained by the player to resolve wagers that may be won even if the player has folded, such as, for example, the bonus wager. The election to fold may be received, for example, by sensing a verbal indication (e.g., a statement, such as “I fold.”) or a visual indication (e.g., a hand wave) from a player or by receiving at a processor 314, 328, or 542 a signal indicative of the election to fold entered by the player through a player interface 232, 316, 432, 520, 550, or 554 (see FIGS. 4 through 8).

If the player places the second wager, the first wager may remain in play. The second wager may comprise, for example, an additional wager or a play wager to continue participation in the wagering game without surrendering the amounts of at least the first and blind wagers. As a specific, non-limiting example, the second wager may comprise a play wager equal in amount to the first wager. The outcome of the second wager may be dependent on the same rules that determine the outcome of the first wager. The second wager may be received by performing any of the actions described previously in connection with acceptance of the first wager, with the exception that the chips would be physically received within a second wager position 134 on the playing surface 120 of the playing table (see FIGS. 2 and 3).

A complete hand of cards may be dealt and revealed to at least each player who made the second wager, as indicated at 110. In embodiments where the bonus wager may be won even if a player has elected to fold the first and blind wagers, a complete hand may be dealt and revealed to the players who made the bonus wager as well as the players who made the second wager. The complete hand may be dealt and revealed in stages in some embodiments. In such embodiments, each additional stage may include, for example, repetition of act 108, with third, fourth, etc. play wagers being received to continue participation in at least some wagers (e.g., the first, blind, and second wagers) or elections to fold being received to surrender the at least some wagers. In other embodiments, the complete hand may be dealt and revealed in a single stage. For example, cards may be dealt to each individual player, community cards available to each player may be dealt, previously concealed player cards or community cards may be revealed, or any combination of these may be performed until a complete set of cards from which to form a hand is available to each player still participating in at least one wager. As specific, non-limiting examples, four community cards may be dealt face up and made available to the players, two cards that were previously dealt face down may be turned face up, or five cards may be dealt face up to each player. The complete may be dealt to the players by performing any of the actions described previously in connection with dealing the partial hand to each player. Dealing the complete hand may further comprise, for example, physically turning over cards that were previously dealt face down.

In some embodiments, the dealing portion of dealing the complete hand may be performed at the same time as the partial hand is dealt. For example, all the cards that will eventually be available to the players to form a hand may be dealt in a single act, but only some of the cards may be dealt face up to reveal a partial hand with the others being dealt face down to be revealed for a complete hand later on. As a specific, non-limiting example, each player may be dealt a partial hand of three cards face up with four community cards being dealt face down, which will later be revealed to form the complete hand. In other embodiments, dealing and revealing the complete hand may both be performed at a different stage of the round of play than dealing the partial hand. For example, a partial hand comprising a number of cards smaller than a number of cards required to for a hand may be dealt to each player face up, and the partial hand may be completed by dealing a number of cards that brings the total number of cards available to the player to form a hand to a number greater than or equal to the number of cards required to form a hand. As a specific, non-limiting example, three cards may initially be dealt to each player face up, then four cards may later be dealt to each player face up, which seven total cards may be used to make a five-card hand. In such embodiments, dealing the partial hand and dealing the complete hand may comprise keeping track of physical cards dealt from a deck as they are placed in individual player card areas 126, community card areas (not shown), or both, receiving a partial hand from a card dispensing device 322 (e.g., a card shuffler or a card shoe) and later receiving cards to complete the hand from the card dispensing device 322 (see FIG. 5), or displaying a partial hand on a screen or on screens 274, 316, 330, 432, 464, 460, 520, or 558 for each participating player station (see FIGS. 4 through 8) and later displaying cards to complete the hand on the screen or screens 274, 316, 330, 432, 464, 460, 520, or 558 for each participating player station (see FIGS. 4 through 8), or displaying a virtual (remote) representation of the same cards and hands to some or all of the participants (players).

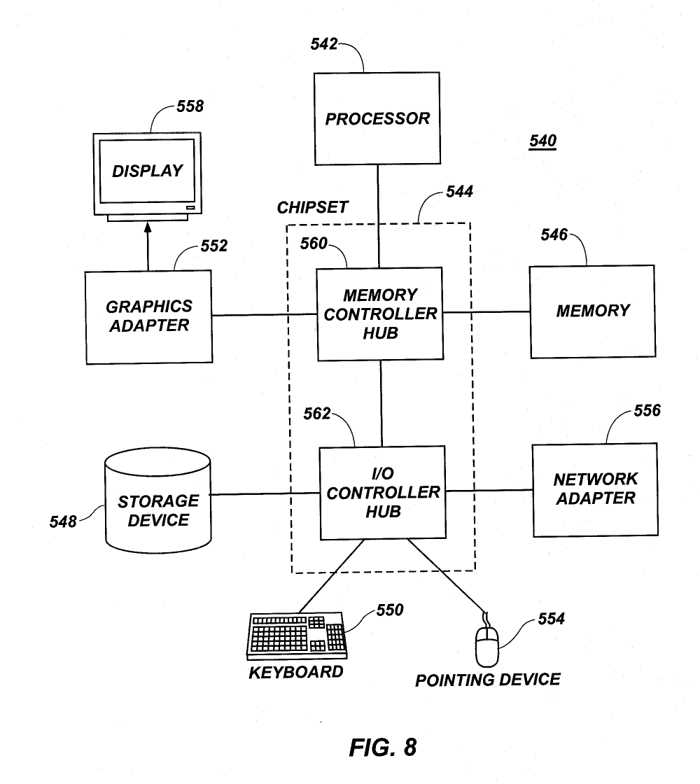

A total number of cards dealt to players, including individual player cards and any community cards, may be greater than a number of cards required to form a hand in some embodiments. For example, players may be dealt seven cards, with five cards being required to form a hand. In such embodiments, the cards may be analyzed to form a best hand from the cards available to each player, which may be performed, for example, visually or by a processor 314, 328, or 542 (see FIGS. 5 and 8). In other embodiments, the total number of cards dealt to players may be equal to the number of cards required to faun a hand. For example, players may be dealt five cards, each of which may be required to be included in the player's hand.

The first and second wager may be taken when the hand of a respective player is ranked lower than the hand of the dealer, as indicated at 112. The blind wager may also be taken when the hand of a respective player is ranked lower than the hand of the dealer. Rankings for the hands may be determined using, for example, the rules of poker or a variant of poker, which are well known in the art. As a specific, non-limiting example, rankings for the hands may be determined using the rules for five-card poker. Taking the wagers may comprise, for example, collecting physical money or representations of money or electronically transferring funds from a player account to a house account. More specifically, taking the wagers may comprise physically retrieving chips from the first, second, and blind wager positions 132, 134, and 136 (see FIGS. 2 and 3) or electronically authorizing transfer of funds from a player account to a house account server 510 using a processor 314, 328, or 542 (see FIGS. 5 and 8).

A payout may be paid on the first and second wagers when a hand of a respective player is ranked higher than the hand of the dealer, as indicated at 114. In some embodiments, the payout paid on the first wager may be different from the payout paid on the second wager. For example, a first, payout equal to the amount of the first wager (i.e., an even-money payout) may be paid for winning the first wager and a second, odds payout may be paid for winning the second wager. As a specific, non-limiting example, increasing amounts may be paid for winning the second wager against increasingly higher-ranked hands held by the dealer. For example, a maximum payout on the second wager may be paid when the player wins against a straight flush held by the dealer (e.g., by forming a higher ranked straight flush or by forming a royal flush), a minimum payout on the second wager may be paid when the player wins against a high card held by the dealer, and decreasing payouts may be paid for winning against hands between a straight flush and high card. As another specific, non-limiting example, increasing amounts may be paid for winning the second wager with increasingly higher ranked hands held by the player, which increasing amounts may be fixed and designated by a pay table. The payout may be paid, for example, by physically giving money or a representation of money to a winning player or by granting electronic authorization to transfer funds to a player account. More specifically, the payout may be paid, for example, by physically placing chips within a player position 122 on a playing surface 120 of a playing table 118 (see FIGS. 2 and 3) or by granting electronic authorization at a processor 314, 328, or 542 to transfer funds from an account server 510 to a player account (see FIGS. 5, 7, and 8).

A payout may be paid on the blind wager when a hand of a respective player is ranked higher than the hand held by the dealer and the hand of the respective player is of a predetermined rank or higher. As discussed previously, the blind wager may be collected by the house when the hand of the player is ranked lower than the hand held by the dealer. The blind wager may be returned to the player (i.e., may be a push) when the hand of the player is of equal rank with the hand of the dealer. When the player's hand outranks the dealer's hand, the blind wager may be returned to the player when the player's hand is ranked lower than a predetermined rank. For example, the blind wager may be a push where the player's hand outranks the dealer's hand, but the player's hand is ranked lower than a straight. When the player's hand outranks the dealer's hand and the player's hand is of a predetermined rank or higher, the payout may be paid on the blind wager. For example, a payout may be paid on the blind wager where the player's hand outranks the dealer's hand and the player's hand is a straight or better. As a specific, non-limiting example, increasing amounts may be paid for achieving increasingly less likely hands ranked straight or higher where the player's hand outranks the dealer's hand, which increasing amounts may be fixed and designated by a pay table. Paying the payout on the blind wager may comprise performing any of the acts described previously in connection with paying the payouts on the first and second wagers.

A payout may be paid on the bonus wager when a hand of a respective player is of a predetermined rank or higher. For example, the payout on the bonus wager may be paid when the player's hand is three of a kind or better (i.e., a trips payout). As a specific, non-limiting example, increasing payouts may be paid on the bonus wager for achieving increasingly higher ranked hands of three of a kind or better, with fixed amounts for specific hands being designated by a pay table. The payout for the bonus wager may be paid even when a player previously folded, surrendering the first and blind wagers, in some embodiments. In other embodiments, the payout for the bonus wager may only be paid when a player has not folded. Paying the payout on the bonus wager may comprise performing any of the acts described previously in connection with paying the payouts on the first and second wagers.

Various platforms are contemplated that are suitable for implementation of embodiments of wagering games according to the present disclosure. For example, embodiments of wagering games may be implemented such that one or more players may place wagers and engage in game play according to the rules of the wagering games. For example, wagering games may be implemented on gaming tables, which may include physical gaming features, such as physical cards, physical chips, and may include a live dealer. More specifically, a live dealer may deal physical cards, accept wagers, issue payouts, and perform other administrative functions of game play. Some embodiments may be implemented on electronic devices enabling electronic gaming features, such as providing electronic displays for display of virtual cards, virtual chips, game instructions, pay tables, etc. Some embodiments may include features that are a combination of physical and electronic features.

As an example, embodiments of wagering games may be implemented on an individual gaming device for accepting wagers that has a display screen and inputs for enabling game play of the wagering games. Such an individual gaming device may be linked with other gaming devices that may be operated, for example, by other players. Some individual electronic gaming devices may be referred to as an individual player “cabinet” and may be stationary, such as being located on a casino floor. Other individual electronic gaming devices may be portable devices that may be carried to different locations by the player. Portable devices may include both display of the ongoing game play and input reception for game play by a player, or may be for receiving input from a player while the game play is displayed on a public monitor, or other display device.

Referring to FIG. 2, a diagram of a playing surface 120 of a gaming table 118 for implementation of the wagering game is shown. Such an implementation may comprise a felt layout on a physical gaming table 118 or 300 (see FIGS. 2 and 5) or an electronic representation on a video display 274, 316, 330, 432, 464, 460, 520, or 558 for each participating player station 122 (see FIGS. 4 through 8). The playing surface 120 may define a plurality of participating player positions 122 within which the activity (e.g., wagering and card dealing) for individual players may take place and a dealer position 124 including a dealer card area 128 within which the activity (e.g., card dealing, wager collecting, and payout making) for the dealer may take place. The playing surface 120 may also define a common card position (not shown) within which common cards may be dealt.

Referring to FIG. 3, an enlarged diagram of one of the player positions 122 of FIG. 2 is shown. Each player position 122 may define a player card area 126 in which player cards may be dealt. Each player position may further define a first wager (e.g., an ante wager) position 132 within which representations of money may be placed or displayed when the first wager is accepted, a second wager (e.g., a play wager) position 134 within which representations of money may be placed or displayed when the second wager is accepted, a blind wager position 136 within which representations of money may be placed or displayed when a blind wager is accepted, and a bonus wager position 138 within which representations of money may be placed or displayed when the bonus wagers is accepted. Each player position may further define a second wager pay table area 140, which may show payout odds for winning against specific hand rankings held by the dealer, a blind wager pay table area 142, which may show payout odds for holding a hand ranked higher than the dealer's hand and of a predetermined rank or higher, and a bonus wager pay table area 144, which may show payout odds for holding a hand of a predetermined rank or higher.

With combined reference to FIGS. 2 and 3, a specific physical implementation of the wagering game described in connection with FIG. 1 is presented. Mandatory first and blind wagers may be accepted, which may be reflected by the presence of physical chips or electronic representations of chips in the first and blind wager positions 132 and 136. Optional bonus wagers may also be accepted, which may be reflected by the presence of physical chips or electronic representations of chips in the bonus wager position 138.

A partial hand comprising three cards may be dealt face up to each player position 122, which may be reflected by the presence of physical cards or electronic representations of cards face up in the player card area 126 of each player position 122. A complete hand comprising seven cards may be dealt face up to the dealer, which may be reflected by the presence of physical cards or electronic representations of cards in the dealer card area 128. Using the seven cards, the dealer may form a best five-card hand to be played against the individual players' hands if the players do not fold. If the best five-card hand held by the dealer is ranked lower than a pair, all first wagers are returned to the players (i.e., they are a push), which may be reflected by removal of physical chips from the first wager position 132. Players may still be eligible to win the blind and bonus wagers, and those actions associated with resolving the blind and bonus wagers, as described below, may be performed during the remainder of the round of play.

After viewing their partial hands and the dealer's complete hand, the players may elect to fold or place the second wager. The election to fold may be reflected by the removal of the physical chips from the first and blind wager positions 132 and 136. Acceptance of the second wager may be reflected by the presence of physical chips or electronic representations of chips in the second wager position 134.

The partial hands dealt to the players may be completed by dealing four more cards face up to each player position 122 where the player did not fold or the player made the bonus wager, which may be reflected by the presence of more physical cards in the player card area 126 of each player position 122. A best five-card poker hand may be formed from the seven cards available to each player position 122, and the wagers may be resolved.

The first wager may be collected from each player who did not fold and whose hand does not outrank the dealer's hand, which may be reflected by the removal of physical chips from the first wager position 132. An even-money payout may be paid to each player who did not fold and whose hand outranks the dealer's hand, which may be reflected by the presence of physical chips in the respective player positions 122 or an equivalent wager made remotely.

The second wager may be collected from each player who made the second wager and whose hand is outranked by the dealer's hand, which may be reflected by the removal of physical chips from the second wager position 134. An even-money payout may be paid to each player who made the second wager, whose hand outranks the dealer's hand, and whose beat a dealer hand ranked lower than two pair, which may be reflected by the presence of physical chips in the respective player positions 122. An odds payout may be paid to each player who made the second wager, whose hand outranks the dealer's hand, and who beat a dealer hand ranked two pair or better, with increasing amounts being paid for winning against higher ranked dealer hands according to the following pay table:

| Dealer Hand Beaten | Odds Payout |
|---|---|
| Straight Flush | 1,000 to 1 |
| Four of a Kind | 500 to 1 |
| Full House | 100 to 1 |
| Flush | 50 to 1 |
| Straight | 10 to 1 |
| Three of a Kind | 8 to 1 |
| Two Pair | 4 to 1 |

The blind wager may be collected from each player who did not fold and whose hand is outranked by the dealer's hand, which may be reflected by the removal of physical chips from the blind wager position 136. The blind wager may be returned (i.e., may be a push) to each player who did not fold, whose hand outranks the dealer's hand, but whose hand is ranked lower than a straight. An odds payout may be paid to each player who did not fold, whose hand outranks the dealer's hand, and whose hand is ranked a straight or higher, with increasing amounts being paid for achieving higher ranked player hands according to the following table:

| Player Hand | Odds Payout |
|---|---|
| Royal Flush | 500 to 1 |
| Straight Flush | 50 to 1 |
| Four of a Kind | 10 to 1 |
| Full House | 3 to 1 |
| Flush | 3 to 2 |
| Straight | 1 to 1 |

The bonus wager may be collected from each player whose hand is ranked lower than three of a kind, which may be reflected by the removal of physical chips or electronic representations of chips from the bonus wager position 138. An odds payout may be paid to each player whose hand is ranked a three of a kind or higher, with increasing amounts being paid for achieving higher ranked player hands according to the following table:

| Player Hand | Odds Payout |
|---|---|
| Royal Flush | 50 to 1 |
| Straight Flush | 40 to 1 |
| Four of a Kind | 30 to 1 |
| Full House | 8 to 1 |
| Flush | 6 to 1 |
| Straight | 5 to 1 |
| Three of a Kind | 3 to 1 |

While a general game structure, including several variations, and a particular embodiment of a wagering game according to the present disclosure have been described, the concepts of dealing a complete dealer's hand face up before the players choose to fold or play, paying increasing amounts for winning against dealer hands of increasingly higher rank, or both in combination with one another may be applied to other card wagering games. Such wagering games may be implemented on gaming devices, gaming tables, game servers, and other structures, such as, for example, those shown in the following figures.

Referring to FIG. 4, an example of an individual electronic gaming device 200 configured for embodiments of wagering games according to the present disclosure is shown. The individual electronic gaming device 200 may include an individual player position 214 that includes a player area 232 for a player to interact with the individual electronic gaming device 200. The electronic gaming device 200 may include a gaming screen 274 configured to display indicia for interacting with the individual electronic gaming device 200, such as through processing one or more stored programs to implement the rules of game play at the individual electronic gaming device 200. Accordingly, game play may be accommodated without involving physical playing cards, poker chips, and/or live personnel. The action may instead be simulated by a control processor (not shown) interacting with and controlling the individual electronic gaming device 200. Although the figure has an outline of a traditional gaming cabinet, gaming device 200 may be implemented in any manner ways, including but not limited to client software downloaded to a portable device such as a smart phone, tablet, or laptop PC. Gaming device 200 may also be a non-portable PC or other computing device. In some embodiments, client software is not downloaded but is native to the device, or otherwise delivered with the device when received by a player.

The gaming screen 274 may be carried by a generally vertically extending cabinet 276 of the individual electronic gaming device 200. The individual electronic gaming device 200 may further include banners (not shown) configured to communicate rules of game play and/or the like, such as along a top portion 278 of the cabinet 276 of the gaming device 200. The individual electronic gaming device 200 may further include additional decorative lights (not shown), and speakers (not shown) for transmitting and/or receiving sounds during game play. Further detail of an example of an individual electronic gaming device (as well as other embodiments of tables and devices) is disclosed in U.S. patent application Ser. No. 13/215,156, filed Aug. 22, 2011, and titled “SIX-CARD POKER GAME,” the disclosure of which is incorporated herein in its entirety by this reference.

Some embodiments may be implemented at locations that include a plurality of player stations. Such player stations may include an electronic display screen for display of game information, such as displaying virtual cards, virtual chips, and game instructions, and for accepting wagers and facilitating credit balance adjustments. Such player stations may, optionally, be integrated in a table format. While some features may be automated through electronic interfaces (e.g., virtual cards, virtual chips, etc.), some features may remain in the physical domain. As such, the game play may be administered by a live dealer, a virtual dealer, or a combination of both.

Referring to FIG. 5, an example of a suitable table 300 configured for implementation of embodiments of wagering games according to the present disclosure is shown. The table 300 may include a playing surface 304. The table 300 may include a plurality of player stations 312a-312g. Each player station 312a-312g may include a player interface 316a-316g, which may be used for display of game information (e.g., game instructions, input options, wager information including virtual chips, game outcomes, etc.). The player interface 316a-316g may include a display screen in the form of a touch screen, which may be at least substantially flush with the playing surface 304 in some embodiments. Each player interface 316a-316g may be coupled respectively with its own game processor 314a-314g (shown in dashed lines), although in some embodiments, a central game processor 328 (shown in dashed lines) may be employed. In some embodiments, a combination of individual game processors 314a-314g and a central game processor 328 may be employed.

The table 300 may further include additional features, such as a dealer chip tray 320, which may be used by the dealer to cash players in and out of the wagering game, whereas wagers and balance adjustments during game play may be performed using virtual chips. For embodiments using physical cards 306a, 306b, the table 300 may further include a card handling device 322 that may be configured to shuffle, read, and deliver physical cards for the dealer and players to use during game play or, alternatively, a card shoe configured to read and deliver cards that have already been randomized. For embodiments using virtual cards, such virtual cards may be displayed at the individual player interfaces 316a-316g. Common virtual cards may be displayed in a common card area (not shown).

The table 300 may further include a dealer interface 318, which, like the player interfaces 314a-314g, may include touch screen controls for assisting the dealer in administering the wagering game. The table 300 may further include an upright display 330 configured to display images that depict game information such as pay tables, hand counts, historical win/loss information by player, and a wide variety of other information considered useful to the players. The upright display 330 may be double sided to provide such information to players as well as to the casino pit.

Further detail of an example of a table and player displays is disclosed in U.S. Patent Application Pub. No. 2010/0016050, filed Jul. 15, 2008, and titled “Split Screen on a Chipless Gaming Table,” the disclosure of which is incorporated herein in its entirety by this reference. Although an embodiment is described showing individual discrete player stations, in some embodiments, the entire playing surface 304 may be an electronic display that is logically partitioned to permit game play from a plurality of players for receiving inputs from, and displaying game information to, the players, the dealer, or both.

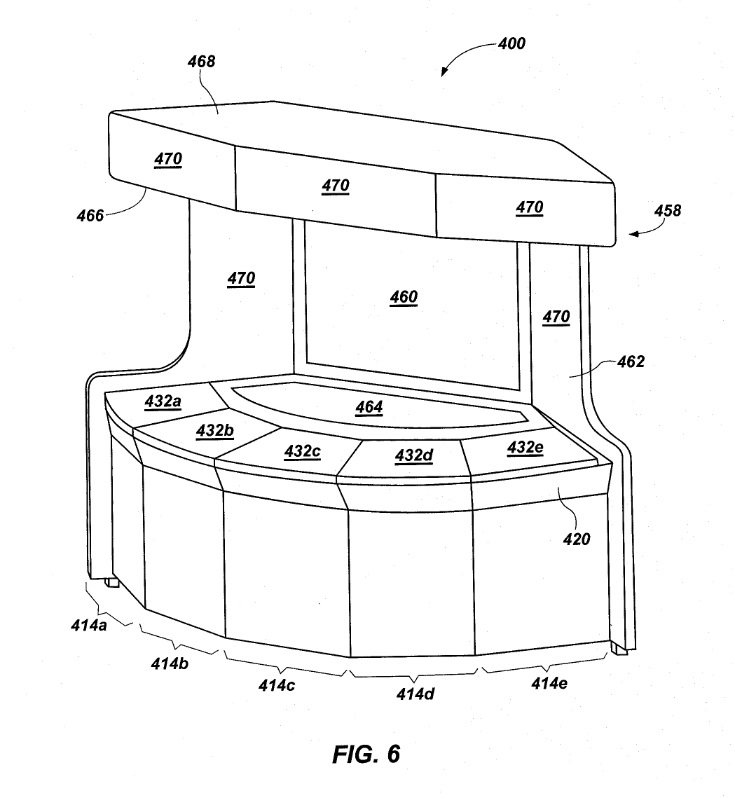

Referring to FIG. 6, another example of a suitable table 400 configured for implementation of embodiments of wagering games having a virtual dealer according to the present disclosure is shown. The table 400 may include player positions 414 that are arranged in a bank about an arcuate edge 420 of a video device 458 that may comprise a card screen 464 and a dealer screen 460. The dealer screen 460 may display a video simulation of the dealer (i.e., a virtual dealer) for interacting with the video device 458, such as through processing one or more stored programs to implement the rules of game play at the video device 458. The dealer screen 460 may be carried by a generally vertically extending cabinet 462 of the video device 458. The card screen 464 may be configured to display at least one or more of the dealer's cards, community cards, and/or player's cards by the virtual dealer on the dealer screen 460 (virtual dealer not shown in FIG. 5).

Each of the player positions 414a-414e may include a player area 432a-432e which is configured for wagering and game play interactions with the video device 458 and/or virtual dealer. Accordingly, game play may be accommodated without involving physical playing cards, poker chips, and/or live personnel. The action may instead be simulated by a control processor (not shown) interacting with and controlling the video device 458. The control processor may be located internally within, or otherwise proximate to, the video device 458. The control processor may be programmed, by known techniques, to implement the rules of game play at the video device 458. As such, the control processor may interact and communicate with display/input interfaces and data entry inputs for each player area 432a-432e of the video device 458. Other embodiments of tables and gaming devices may include a control processor that may be similarly adapted to the specific configuration of its associated device.

The video device 458 may further include banners (not shown) configured to communicate rules of play and/or the like, which may be located along one or more walls 470 of the cabinet 462. The video device 458 may further include additional decorative lights (not shown) and speakers (not shown), which may be located on an underside surface 466, for example, of a generally horizontally depending top 468 of the cabinet 462 of the video device 458 generally extending towards the player positions 414a-414e.

Further details of an example of a table and player displays are disclosed in U.S. Patent Application Pub. No. 2005/0164762, filed Jan. 26, 2004, and titled “Automated Multiplayer Game table with Unique Image Feed of Dealer,” the disclosure of which is incorporated herein in its entirety by this reference. Although an embodiment is described showing individual discrete player stations, in some embodiments, the entire playing surface (e.g., player areas 432a-432e, card display 464, etc.) may be an electronic display that is logically partitioned to permit game play from a plurality of players for receiving inputs from, and displaying game information to, the players, the dealer, or both.

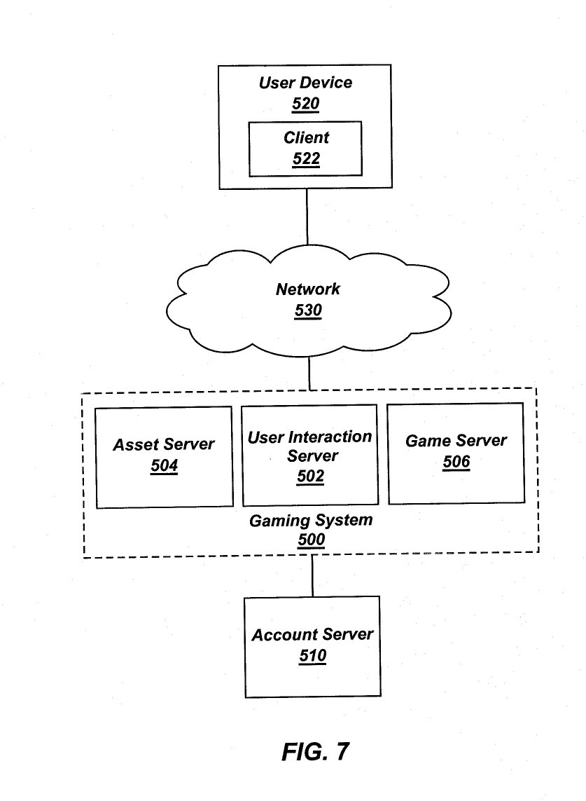

Wagering games in accordance with embodiments of the disclosure may be administered over the Internet, or otherwise on-line, in one embodiment using a gaming system employing a client server architecture. Referring to FIG. 7, a schematic block diagram of a gaming system 500 for implementing wagering games according to an embodiment is shown. The gaming system 500 enables end users to access proprietary and/or non-proprietary game content. Such game content may include, without limitation, various types of wagering games such as card games, dice games, big wheel games, roulette, scratch off games (“scratchers”), and any other wagering game where the game outcome is, in part or in whole, determined by one or more random events. This includes, but is not be limited to, Class II and Class III games as defined under 25 U.S.C. §2701 et seq. (“Indian Gaming Regulatory Act”). Such games may include banked and/or non-banked games.

The wagering games supported by the gaming system 500 may be operated with real currency or with virtual credits or other virtual (in one embodiment, electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including but not limited to a player purchasing credits, being awarded credits as part of a contest or a win event in this or another game (including non-wagering games), being awarded credits as a reward for use of a product, casino or other enterprise, time played in one session, games played, or may be as simple as virtual credits upon logging in at a particular time or with a particular frequency, etc. Although credits may be won or lost, the ability of the player to cash out credits may be controlled or prevented. In one example, credits acquired (in one embodiment, purchased, in other embodiments, not purchased but awarded) for use in a play for fun game may be limited to non-monetary redemption items, awards, or credits usable in the future or for another game or gaming session. The same credit redemption restrictions may be applied to some or all of credits won in a wagering game as well.

An additional variation includes sites having both play for fun and wagering games, including issuance of free credits usable to play the play for fun games. This may attract players to the site and to the games before they engage in wagering. In some embodiments, a limited number of free or promotional credits may be issued to entice players to play the games. Another method of issuing credits includes free credits in exchange for identifying friends who may want to play. In another embodiment, additional credits may be issued after a period of time has elapsed to encourage the player to resume playing the game. The system may enable players to buy additional game credits to allow the player to resume play. Objects of value may be awarded to play for fun players, which may or may not be in a direct exchange for credits. For example, a prize may be awarded or won for a highest scoring play for fun player during a defined time interval. All variations of credit redemption are contemplated, as desired by game designers and game hosts (the person or entity controlling the hosting systems).

The gaming system 500 may include a gaming platfoim that establishes a portal for an end user to access a wagering game hosted by a game server 506 through a user interaction server 502. The user device 520 may communicate with a user interaction server 502 of the gaming system 500 using a network 530 (e.g., the Internet). The user interaction server 502 may communicate with the game server 506 and provide game information to the user. In some embodiments, the game server 506 may also be a game engine. In some embodiments, a single user device communicates with a game provided by the game server 506, while other embodiments may include a plurality of user devices 520 configured to communicate and provide end users with access to the same game provided by game server 506. In addition, a plurality of end users may access a single user interaction server 502, or, a plurality of user interaction servers 502 to access game server 506.

The user interaction server 502 may communicate with the user device 520 to enable access to the gaming system 500. The user interaction server 502 may enable a user to create and access a user account and interact with gaming server 506. The user interaction server 502 may enable users to initiate new games, join existing games, and interface with games being played by the user.

The user interaction server 502 may also provide a client 522 for execution on the user device for accessing the gaming system 500. The client 522 provided by the gaming system 500 for execution on the user device 520 can comprise a variety of implementations according to the user device and method of communication with the gaming system 500. In one embodiment, the user device 520 connects to the gaming system 500 using a web browser and the client 522 executes within a browser window or frame of the web browser. In another embodiment, the client 522 is a stand-alone executable on the user device 520.

In one embodiment, the client 522 may comprise a relatively small amount of script (e.g., JavaScript), also referred to as a “script driver,” including scripting language that controls an interface of the client 522. The script driver may include simple function calls requesting information from the gaming system 500. In other words, the script driver stored in the client 522 may merely include calls to functions that are externally defined by, and executed by, the gaming system 500. As a result, the client 522 may be characterized as a “thin client.” As that term is used herein, the client 522 may be little more than a script player. The client 522 may simply send requests to the gaming system 500 rather than performing logic itself. The client 522 receives player inputs and the player inputs are passed to gaming system 500 for processing and executing the wagering game. In one embodiment, this includes providing specific graphical display information to client 522 as well as game outcomes.

In other embodiments, the client 522 comprises an executable rather than a script. In that case, client 522 may do more local processing than does a script driver, such as calculating where to show what game symbols upon receiving a game outcome from game server 506 through user interaction server 502. In one embodiment, it may be that portions of asset server 504 are loaded onto the client 522, and used by the client in processing and updating graphical displays. Due to security and integrity concerns, most embodiments will have the bulk of the processing of the game play performed in the gaming system 500. However, some embodiments may include significant game processing by client 522 when the client and user device 520 are considered trustworthy, or, when there is reduced concern for security and integrity in the displayed game outcome. In most embodiments, it is expected that some form of data protection, such as end-to-end encryption, will be used when data is transported over network 530. Network 530 may be any network, including but not limited to the Internet.

In an embodiment where the client 522 implements further logic and game control methodology beyond the thin client, the client 522 may parse and define player interactions prior to passing the player interactions to the gaming system 500. Likewise, when the client 522 receives a gaming interaction from the gaming system 500, the client 522 may be configured to determine how to modify the display as a result of the gaming interaction. The client 522 may also allow the player to change a perspective or otherwise interact with elements of the display which do not change aspects of the game.

The gaming system 500 may include an asset server 504 which may host various media assets (e.g., audio, video, and image files) that may be sent to the client 522 for presenting the various wagering games to the end user. In other words, in this embodiment the assets presented to the end user may be stored separately from the client 522. In one embodiment, the client 522 requests the assets appropriate for the game played by the user; in other embodiments, especially those using thin clients, just those assets that are needed for a particular display event will be sent by game server 500 when the game server determines they are needed, including as few as one asset. In one example, the client 522 may call a function defined at the user interaction server 502 or asset server 504 which may determine which assets are to be delivered to the client 522 as well as how the assets are to be presented by the client 522 to the end user. Different assets may correspond to the various clients that may have access to the game server 506 or to different games to be played.

The game server 506 is configured to perform game play methods and determine game play outcomes that are provided to the user interaction server 502 to be transmitted to user device 520 for display on the end user's computer. For example, the game server 506 may include game rules for one or more wagering games, such that the game server 506 controls some or all of the game flow for a selected wagering game, as well as the determining game outcomes. Game server 506 may include pay tables and other game logic. The game server 506 also performs random number generation for determining random game elements of the wagering game. In one embodiment, the game server 506 is separated from the user interaction server 502 by a firewall or other method of preventing unauthorized access to the game server 506 from the general members of the network 530.

The user device 520 may present a gaming interface to the player and communicate the user interaction to the gaming system 500. The user device 520 may be any electronic system capable of displaying gaming information, receiving user input, and communicating the user input to the gaming system 500. As such, the user device 520 can be a desktop computer, a laptop, tablet computer, set-top box, mobile device including but not limited to smart phones, kiosk, terminal, or other computing device. The user device 520 may operate the client 522 for connecting to the interactive gaming system 200 as described above. The client 522 may be a specialized application or may be executed within a generalized application capable of interpreting instructions from the interactive gaming system 500, such as a web browser.

The client 522 may interface with an end user through a web page, or an application that runs on a device including but not limited to a smartphone, tablet, or general computer, or be any other computer program configurable to access the gaming system 500. The client 522 may be illustrated within a casino webpage (or other interface) indicating that the client 522 is embedded into a webpage, which is supported by a web browser executing on the client device 520.

In one embodiment, the gaming system 500 may be operated by different entities. The user device 520 may be operated by a third party, such as a casino or an individual, that links to the gaming system 500, which may be operated, for example, by a wagering game service provider. Therefore, in some embodiments, the user device 520 and client 522 may be operated by a different administrator than the operator of the game server 506. In other words, the user device 520 may be part of a third-party system that does not administer or otherwise control the gaming system 500 or game server 506. In another embodiment, the user interaction server 502 and asset server 504 are provided by a third-party system. For example, a gaming entity (e.g., a casino) may operate the user interaction server 502 or user device 520 to provide its customers access to game content managed by a different entity which may control game server 506, amongst other functionality. In some embodiments, these functions are operated by the same administrator. For example, a gaming entity (e.g., a casino) may elect to perform each of these functions in-house, such as providing both the access to the user device 520 and the actual game content and providing administration of the gaming system 500.

The gaming system 500 may communicate with external account servers 510, optionally through another firewall. For example, the gaming system 500 itself may not directly accept wagers or issue payouts. That is, the gaming system 500 may facilitate online casino gaming, but may not be part of a self-contained online casino itself. Instead, the gaming system 500 may facilitate the play of wagering games owned and controlled by a company offering games and gaming products and services, such as Shuffle Master, Inc. Another entity (e.g., a casino or any account holder or financial system of record) may operate and maintain its external account servers 510 to accept bets and make payout distributions. The gaming system 500 may communicate with the account servers 510 to verify the existence of funds for wagering, and instruct the account server 510 to execute debits and credits.

In some embodiments, the gaming system 500 may directly accept bets and make payout distributions, such as in the case where an administrator of the gaming system 500 operates as a casino. As discussed above, the gaming system 500 may be integrated within the operations of a casino rather than separating out functionality (e.g., game content, game play, credits, debits, etc.) among different entities. In addition, for play for fun wagering games, the gaming system 500 may issue credits, take bets, and manage the balance of the credits according to the game outcomes, but may not permit payout distributions or be linked to account server 510 that permits payout distributions. Such credits may be issued for free, through purchase, or for other reasons, without the ability for the player to cash out. Such play for fun wagering games may be played on platforms that do not permit traditional gambling, such as to comply with jurisdictions that do not permit online gambling.

The gaming system 500 may be configured in many ways, from a fully integrated single system to a distributed server architecture. The asset server 504, user interaction server 502, game server 506, and account server 510 may be configured as a single, integrated system of code modules running on a single server or machine, where each of the servers is functionality implemented on a single machine. In such a case, the functionality described herein may not be implemented as separate code modules. The asset server 504, user interaction server 502, game server 506, and account server 510 may also be implemented as a plurality of independent servers, each using its own code modules running on a separate physical machine, and may further include one or more firewalls between selected servers (depending on security needs). Each server could communicate over some kind of networked connection, potentially as varied as that described for network 530. Further, each single server shown in FIG. 7 may be implemented as a plurality of servers with load balancing and scalability factors built into the embodiment. All such embodiments and variations are fully contemplated.

Additional features may be supported by the game server 506, such as hacking and cheating detection, data storage and archival, metrics generation, messages generation, output formatting for different end user devices, as well as other features and operations. For example, the gaming system 500 may include additional features and configurations as described in U.S. patent application Ser. No. 13/353,194, filed Jan. 18, 2012, and titled “Network Gaming Architecture, Gaming Systems, and Related Methods,” which is incorporated by reference herein in its entirety by this reference.

The network 530 may enable communications between the user device 520 and the gaming system 500. A network (not shown) may also connect the gaming system 500 and account server 510, and further one or more networks may interconnect one or more of the other servers shown collectively as game system 500. In one embodiment, the network 530 uses standard communications technologies and/or protocols. Thus, the network 530 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 530 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 530 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 530 can include links comprising one or more networks such as the Internet.

Referring to FIG. 8, a high-level block diagram of a computer 540 for acting as a gaming system 500 according to one embodiment is shown. Illustrated are at least one processor 542 coupled to a chipset 544. Also coupled to the chipset 544 are a memory 546, a storage device 548, a keyboard 550, a graphics adapter 552, a pointing device 554, and a network adapter 556. A display 558 is coupled to the graphics adapter 552. In one embodiment, the functionality of the chipset 544 is provided by a memory controller hub 560 and an I/O controller hub 562. In another embodiment, the memory 546 is coupled directly to the processor 542 instead of the chipset 544.

The storage device 548 is any non-transitory computer-readable storage medium, such as a hard drive, compact disk read-only memory (CD-ROM), DVD, or a solid-state memory device (e.g., a flash drive). The memory 546 holds instructions and data used by the processor 542. The pointing device 554 may be a mouse, track ball, or other type of pointing device, and is used in combination with the keyboard 550 to input data into the computer system 540. The graphics adapter 552 displays images and other information on the display 558. The network adapter 556 couples the computer system 540 to a local or wide area network.

As is known in the art, a computer 540 can have different and/or other components than those shown in FIG. 8. In addition, the computer 540 can lack certain illustrated components. In one embodiment, a computer 540 acting as a gaming system 500 lacks a keyboard 550, pointing device 554, graphics adapter 552, and/or display 558. Moreover, the storage device 548 can be local and/or remote from the computer 540 (such as embodied within a storage area network (SAN)).

The gaming system 500 may comprise several such computers 540. The gaming system 500 may include load balancers, firewalls, and various other components for assisting the gaming system 500 to provide services to a variety of user devices.

As is known in the art, the computer 540 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 548, loaded into the memory 546, and executed by the processor 542.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “determining,” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware, or hardware, and when embodied in software, could be downloaded to reside on and be operated from different platforms used by a variety of operating systems. The embodiments can also be in a computer program product which can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Additional, non-limiting example embodiments include the following:

### Embodiment 1

A method of administering a wagering game comprises accepting an initial wager from each player; dealing a partial hand to each player, at least one card of the partial hand for each player being dealt face up; dealing a complete hand to the dealer, face up; receiving from each player an election to fold, wherein the initial wager is collected by the house, or an additional wager, wherein the initial wager remains in play; dealing additional cards to complete a hand to each player who made the additional wager and revealing the complete hand for each player who made the additional wager; taking the initial and additional wagers when a hand of a respective player is ranked lower than the hand of the dealer; and paying a payout when a hand of a respective player is ranked higher than the hand of the dealer.

### Embodiment 2

The method of Embodiment 1, wherein at least one of dealing the partial hand to each player and dealing the additional cards to complete a hand to each player comprises dealing community cards available to each player to form the hand of each respective player.

### Embodiment 3

The method of Embodiment 2, wherein dealing the complete hand to the dealer comprises dealing the community cards available to each player.

### Embodiment 4

The method of any one of Embodiments 1 through 3, wherein dealing the complete hand to the dealer and dealing the additional cards to complete a hand to each player comprises dealing a number of cards to the dealer and to each player greater than a number of cards used to form the complete hands of the dealer and each player, the method further comprising forming a best hand for the dealing and each player from the cards available to the dealer and each player

### Embodiment 5

The method of any one of Embodiments 1 through 4, wherein paying the payout comprises: paying an even money payout on the initial wager; and paying an odds payout according to a pay table on the additional wager.

### Embodiment 6

The method of Embodiment 5, wherein paying the odds payout on the additional wager comprises paying increasing amounts for winning against increasingly higher-ranked hands held by the dealer.

### Embodiment 7

The method of any one of Embodiments 1 through 6, further comprising: accepting a blind wager from at least one player; and awarding an odds payout according to a pay table on the blind wager when the hand of the at least one player is ranked higher than the hand of the dealer.

### Embodiment 8

The method of any one of Embodiments 1 through 7, further comprising: accepting a bonus wager from at least one player; and awarding an odds payout according to a pay table on the bonus wager when the hand of the at least one player is of a selected rank or higher.

### Embodiment 9

The method of Embodiment 8, wherein awarding the odds payout comprises awarding the odds payout to a player irrespective of whether the player elected to fold.

### Embodiment 10

The method of any one of Embodiments 1 through 9, further comprising returning at least the first wager to each player when the hand of the dealer is ranked lower than a predetermined hand rank and restarting the wagering game before receiving the election to fold or the additional wager from each player.

### Embodiment 11

The method of Embodiment 10, wherein returning at least the first wager to each player when the hand of the dealer is ranked lower than the predetermined hand rank comprises returning at least the first wager to each player when the hand of the dealer is ranked lower than a pair.

### Embodiment 12

A method of administering a wagering game comprises accepting an initial wager from each player; dealing a partial hand to each player, at least one card of the partial hand for each player being dealt face up; dealing a complete hand to the dealer; receiving from each player an election to fold, wherein the initial wager is collected by the house, or an additional wager, wherein the initial wager remains in play; dealing additional cards to complete a hand to each player who made the additional wager and revealing the complete hand for each player who made the additional wager; taking the initial and additional wagers when a hand of a respective player is ranked lower than the hand of the dealer; paying a first payout on the initial wager when a hand of a respective player is ranked higher than the hand of the dealer; and paying a second, odds payout according to a pay table on the additional wager when the hand of the respective player is ranked higher than the hand of the dealer, wherein increasing amounts are paid for winning against increasingly higher-ranked hands held by the dealer.

### Embodiment 13

The method of Embodiment 12, wherein dealing the complete hand to the dealer comprises dealing the complete hand to the dealer, face up.

### Embodiment 14

The method of Embodiment 12 or Embodiment 13, further comprising: accepting a bonus wager from at least one player; and awarding an odds payout according to a pay table on the bonus wager when the hand of the at least one player is of a selected rank or higher.

### Embodiment 15

The method of Embodiment 14, wherein awarding the odds payout comprises awarding the odds payout to a player irrespective of whether the player elected to fold.

### Embodiment 16

A method of administering a wagering game comprises a dealer accepting an ante wager that a player hand rank will exceed a dealer hand rank; the dealer accepting a blind wager that pays when the player hand beats the dealer hand and the player hand is a predetermined winning hand of at least a selected rank; dealing cards to each player and the dealer; displaying at least one player card to each respective player; receiving either an election from each player to fold or a play wager to continue participation in the game; revealing all player and dealer cards and determining best poker hands from the revealed cards for each respective player and the dealer; taking the ante, blind, and play wagers when the dealer hand outranks the player hand; and paying a payout on the ante and play wagers when the player hand outranks the dealer hand, wherein an odds payout is made on the play wager for winning against predetermined dealer hands.

### Embodiment 17

The method of Embodiment 14, wherein dealing cards to the dealer comprises dealing a complete hand to the dealer, face up.

### Embodiment 18

The method of Embodiment 14 or Embodiment 15, further comprising: accepting a bonus wager from at least one player; and awarding an odds payout according to a pay table on the bonus wager when the hand of the at least one player is of a selected rank or higher.

### Embodiment 19

The method of Embodiment 16, wherein awarding the odds payout comprises awarding the odds payout to a player irrespective of whether the player elected to fold.

### Embodiment 20

A method of administering a wagering game, comprising: a dealer accepting at least one wager from each player; the dealer dealing a complete dealer hand, face up; the dealer dealing at least one player card to each player; the dealer permitting the player to view at least one player card; the dealer receiving an election from each player after viewing the at least one player card to fold or to make a play wager; dealing additional cards to each player still participating to complete a player hand for each respective player; revealing the player cards and determining a best hand composition for each respective player and the dealer; comparing the hand composition of the dealer hand to each player hand using poker rankings to determine whether each respective player wins or loses with respect to the dealer; and awarding a payout to each player holding a winning hand

### Embodiment 21

The method of Embodiment 20, wherein paying the payout comprises: paying a first payout on the at least one wager; and paying a second, odds payout according to a pay table on the additional wager.

### Embodiment 22

The method of Embodiment 21, wherein paying the second, odds payout on the additional wager comprises paying increasing amounts for winning against increasingly higher-ranked hands held by the dealer.

### Embodiment 23

The method of Embodiment 20 or Embodiment 21, further comprising: accepting a bonus wager from at least one player; and awarding an odds payout according to a pay table on the bonus wager when the hand of the at least one player is of a selected rank or higher.

### Embodiment 24

The method of Embodiment 23, wherein awarding the odds payout comprises awarding the odds payout to a player irrespective of whether the player elected to fold.

### Embodiment 25

A gaming apparatus for administering a wagering game, comprising: a playing surface including a player interface for at least one player position; a dealer display area; and at least one processor programmed to: accept an initial wager from the player interface; display a partial hand on the playing surface at the at least one player position, at least one card of the partial hand being displayed face up; display a complete hand on the dealer display area, face up; receive from the player interface an election to fold, wherein the initial wager is collected by the house, or an additional wager, wherein the initial wager remains in play; display additional cards to complete a hand to each player who made the additional wager and reveal the complete hand for each player who made the additional wager; take the initial and additional wagers when a hand of a respective player is ranked lower than the hand of the dealer; and pay a payout when a hand of a respective player is ranked higher than the hand of the dealer.

### Embodiment 26

A gaming apparatus for administering a wagering game, comprising: a playing surface including a player interface for at least one player position; a dealer surface; and at least one processor programmed to: accept an initial wager from the player interface; generate a signal representative of a partial hand dealt to the at least one player position, at least one card of the partial hand being dealt face up; generate a signal representative of a complete hand dealt to the dealer surface, face up; accept from the player interface an election to fold, wherein the initial wager is collected by the house, or an additional wager, wherein the initial wager remains in play; generate a signal representative of additional cards to complete a hand dealt to each player who made the additional wager and reveal the complete hand for each player who made the additional wager; take the initial and additional wagers when a hand of a respective player is ranked lower than the hand of the dealer; and generate a signal representative of a payout paid when a hand of a respective player is ranked higher than the hand of the dealer.

### Embodiment 27

A system for administering a wagering game over a network comprises a game server configured to be accessed by a client server, the game server being programmed to: accept an initial wager authorized over a communication network from at least one remote user device; generate a signal representative of a partial player hand displayed on the at least one remote user device, at least one card of the partial player hand being displayed face up; generate a signal representative of a complete dealer hand displayed on the at least one remote user device, face up; accept from the at least one remote user device an election to fold, wherein authorization to transfer the initial wager to the house is granted by the game server, or an additional wager authorization, wherein the initial wager remains in play; generate a signal representative of additional cards to complete a hand displayed face up on the at least one remote user device responsive to authorization to place the additional wager; authorize transfer of the initial and additional wagers to the house when a hand of a respective player is ranked lower than the hand of the dealer; and authorize a payout to a player account when a hand of a respective player is ranked higher than the hand of the dealer.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being within the scope of embodiments encompassed by the disclosure as contemplated by the inventor.

What is claimed is:

1. A method of administering a wagering game, comprising:
accepting an initial wager from each player;
dealing a partial hand to each player, at least one card of the partial hand for each player being dealt face up;
dealing a complete hand to the dealer, face up;
receiving from each player an election to fold, wherein the initial wager is collected by the house, or an additional wager, wherein the initial wager remains in play;
dealing additional cards to complete a hand to each player who made the additional wager and revealing the complete hand for each player who made the additional wager;
taking the initial and additional wagers when a hand of a respective player is ranked lower than the hand of the dealer; and
paying a payout when a hand of a respective player is ranked higher than the hand of the dealer.

2. The method of claim 1, wherein at least one of dealing the partial hand to each player and dealing additional cards to complete the hand to each player comprises dealing community cards available to each player to form the hand of each respective player.

3. The method of claim 2, wherein dealing the complete hand to the dealer comprises dealing the community cards available to each player.

4. The method of claim 1, wherein dealing the complete hand to the dealer and dealing additional cards to complete the hand to each player comprises dealing a number of cards to the dealer and to each player greater than a number of cards used to form the complete hands of the dealer and each player, the method further comprising forming a best hand for the dealing and each player from the cards available to the dealer and each player.

5. The method of claim 1, wherein paying the payout comprises:
paying an even money payout on the initial wager; and
paying an odds payout according to a pay table on the additional wager.

6. The method of claim 5, wherein paying the odds payout on the additional wager comprises paying increasing amounts for winning against increasingly higher-ranked hands held by the dealer.

7. The method of claim 1, further comprising:
accepting a blind wager from at least one player; and
awarding an odds payout according to a pay table on the blind wager when the hand of the at least one player is ranked higher than the hand of the dealer.

8. The method of claim 1, further comprising:
accepting a bonus wager from at least one player; and
awarding an odds payout according to a pay table on the bonus wager when the hand of the at least one player is of a selected rank or higher.

9. The method of claim 8, wherein awarding the odds payout comprises awarding the odds payout to a player irrespective of whether the player elected to fold.

10. The method of claim 1, further comprising returning at least the first wager to each player when the hand of the dealer is ranked lower than a predetermined hand rank and restarting the wagering game before receiving the election to fold or the additional wager from each player.

11. The method of 10, wherein returning at least the first wager to each player when the hand of the dealer is ranked lower than the predetermined hand rank comprises returning at least the first wager to each player when the hand of the dealer is ranked lower than a pair.

12. A method of administering a wagering game, comprising:
accepting an initial wager from each player;
dealing a partial hand to each player, at least one card of the partial hand for each player being dealt face up;
dealing a complete hand to the dealer;
receiving from each player an election to fold, wherein the initial wager is collected by the house, or an additional wager, wherein the initial wager remains in play;
dealing a complete hand to each player who made the additional wager and revealing the complete hand for each player who made the additional wager;
taking the initial and additional wagers when a hand of a respective player is ranked lower than the hand of the dealer;
paying a first payout on the initial wager when a hand of a respective player is ranked higher than the hand of the dealer; and
paying a second, odds payout according to a pay table on the additional wager when the hand of the respective player is ranked higher than the hand of the dealer, wherein increasing amounts are paid for winning against increasingly higher-ranked hands held by the dealer.

13. The method of claim 12, wherein dealing the complete hand to the dealer comprises dealing the complete hand to the dealer, face up.

14. The method of claim 12, further comprising:
accepting a bonus wager from at least one player; and
awarding an odds payout according to a pay table on the bonus wager when the hand of the at least one player is of a selected rank or higher.

15. The method of claim 14, wherein awarding the odds payout comprises awarding the odds payout to a player irrespective of whether the player elected to fold.

16. A method of administering a wagering game, comprising:
a dealer accepting an ante wager that a player hand rank will exceed a dealer hand rank;
the dealer accepting a blind wager that pays when the player hand beats the dealer hand and the player hand is a predetermined winning hand of at least a selected rank;
dealing cards to each player and the dealer;
displaying at least one player card to each respective player;
receiving either an election from each player to fold or a play wager to continue participation in the game;
revealing all player and dealer cards and determining best poker hands from the revealed cards for each respective player and the dealer;
taking the ante, blind, and play wagers when the dealer hand outranks the player hand; and
paying a payout on the ante and play wagers when the player hand outranks the dealer hand, wherein an odds payout is made on the play wager for winning against predetermined dealer hands.

17. The method of claim 16, wherein dealing cards to the dealer comprises dealing a complete hand to the dealer, face up.

18. The method of claim 16, further comprising:
accepting a bonus wager from at least one player; and
awarding an odds payout according to a pay table on the bonus wager when the hand of the at least one player is of a selected rank or higher.

19. The method of claim 18, wherein awarding the odds payout comprises awarding the odds payout to a player irrespective of whether the player elected to fold.

20. A method of administering a wagering game, comprising:
a dealer accepting at least one wager from each player;
the dealer dealing a complete dealer hand, face up;
the dealer dealing at least one player card to each player;
the dealer permitting the player to view at least one player card;
the dealer receiving an election from each player after viewing the at least one player card to fold or to make a play wager;
dealing additional cards to each player still participating to complete a player hand for each respective player;
revealing the additional cards dealt to each player to complete the player hand and determining a best hand composition for each respective player and the dealer;
comparing the hand composition of the dealer hand to each player hand using poker rankings to determine whether each respective player wins or loses with respect to the dealer; and
awarding a payout to each player holding a winning hand.

21. The method of claim 20, wherein paying the payout comprises:
paying a first payout on the at least one wager; and
paying a second, odds payout according to a pay table on the additional wager.

22. The method of claim 21, wherein paying the second, odds payout on the additional wager comprises paying increasing amounts for winning against increasingly higher-ranked hands held by the dealer.

23. The method of claim 20, further comprising:
accepting a bonus wager from at least one player; and
awarding an odds payout according to a pay table on the bonus wager when the hand of the at least one player is of a selected rank or higher.

24. The method of claim 23, wherein awarding the odds payout comprises awarding the odds payout to a player irrespective of whether the player elected to fold.

25. A gaming apparatus for administering a wagering game, comprising:
a playing surface including a player interface for at least one player position;
a dealer display area; and
at least one processor programmed to:
accept an initial wager from the player interface;
display a partial hand on the playing surface at the at least one player position, at least one card of the partial hand being displayed face up;
display a complete hand on the dealer display area, face up;
receive from the player interface an election to fold, wherein the initial wager is collected by the house, or an additional wager, wherein the initial wager remains in play;
display additional cards to complete a hand to each player who made the additional wager and reveal the complete hand for each player who made the additional wager;
take the initial and additional wagers when a hand of a respective player is ranked lower than the hand of the dealer; and
pay a payout when a hand of a respective player is ranked higher than the hand of the dealer.

26. A gaming apparatus for administering a wagering game, comprising:
a playing surface including a player interface for at least one player position;
a dealer surface; and
at least one processor programmed to:
accept an initial wager from the player interface;
generate a signal representative of a partial hand dealt to the at least one player position, at least one card of the partial hand being dealt face up;
generate a signal representative of a complete hand dealt to the dealer surface, face up;
accept from the player interface an election to fold, wherein the initial wager is collected by the house, or an additional wager, wherein the initial wager remains in play;
generate a signal representative of additional cards to complete a hand dealt to each player who made the additional wager and reveal the complete hand for each player who made the additional wager;
take the initial and additional wagers when a hand of a respective player is ranked lower than the hand of the dealer; and
generate a signal representative of a payout paid when a hand of a respective player is ranked higher than the hand of the dealer.

27. A system for administering a wagering game over a network, comprising:
a game server configured to be accessed by a client server, the game server being programmed to:
accept an initial wager authorized over a communication network from at least one remote user device;
generate a signal representative of a partial player hand displayed on the at least one remote user device, at least one card of the partial player hand being displayed face up;
generate a signal representative of a complete dealer hand displayed on the at least one remote user device, face up;
accept from the at least one remote user device an election to fold, wherein authorization to transfer the initial wager to the house is granted by the game server, or an additional wager authorization, wherein the initial wager remains in play;
generate a signal representative of additional cards to complete a hand displayed face up on the at least one remote user device responsive to authorization to place the additional wager;
authorize transfer of the initial and additional wagers to the house when a hand of a respective player is ranked lower than the hand of the dealer; and
authorize a payout to a player account when a hand of a respective player is ranked higher than the hand of the dealer.
